(19) United States
(12) Patent Application Publication
(10) Pub. No.: US 2006/0205332 A1
(43) Pub. Date: Sep. 14, 2006

(54) Method to remove meat from crabs

(75) Inventors: Errol V. Raghubeer, Federal Way, WA (US); Bick-Ngoc Phan, Tacoma, WA (US); Edmund Y. Ting, Kent, WA (US)

Correspondence Address: HARNESS, DICKEY & PIERCE, P.L.C., P.O. BOX 8910, RESTON, VA, 20195, US

(73) Assignee: Flow International Corporation, Kent, WA (US)

(21) Appl. No.: 11/077,993

(22) Filed: Mar. 11, 2005

(51) Int. Cl. A22C 29/02

(52) U.S. Cl. 452/1

(57) ABSTRACT

Crabs are exposed to water at a temperature of 70-120° F. and a pressure of at least 35,000 psi, thereby denaturing the crab meat protein, allowing for the easy and complete removal of the meat as well as the visceral mass and gonadal materials from the exoskeleton and body cavities of the crabs, and preventing unwanted darkening of the meat. As a result, the quantity and quality of meat recovered from crabs are optimized, as opposed to conventional systems that involve cooking the meat to remove it from the crab.

### BACKGROUND OF THE INVENTION

1. Field of the Invention

This invention relates to the high-pressure treatment of crabs, to improve the ease with which meat is extracted from the crabs and maximize the quantity and quality of the extracted meat.

2. Description of the Related Art

The conventional approach for extracting meat from crabs is to cook the crabs, for example with hot water or steam, and then use various tools to manually remove the meat. In addition, automated equipment such as rollers is used to recover meat from selected segments of the crabs. The disadvantages of these conventional methods include the poor recovery of meat, due to incomplete detachment of meat from the skeleton, damage to larger meat segments, which decreases the market value of the meat, and the incorporation of pieces of skeletal material in the meat, which also decreases meat quality and economic value.

Applicants believe that it is possible to provide an improved method for extracting meat from crab, while maximizing the quantity, quality and market value of the meat obtained from each crab. The present invention is directed to such methods.

### BRIEF SUMMARY OF THE INVENTION

Briefly, the present invention improves the quantity, quality and market value of meat recovered from crabs, by exposing the crabs to high hydrostatic pressure at selected temperatures, process parameters being selected in accordance with various embodiments of the present invention.

By exposing the crabs to selected pressure and temperature conditions, the crab meat protein is marginally denatured, which overcomes the fluidity or liquid gel nature of raw crab meat, while still leaving the crab meat in an uncooked condition. Processing crabs in accordance with the present invention enables the easy and complete removal of the meat from the exoskeleton and internal membranes of the crabs. The present invention also facilitates the easy removal of visceral mass and gonadal materials from the body cavity of crabs, which further facilitates the separation of these materials from the crab meat, increasing the market value of the meat and the separated materials. An additional benefit of the methods described herein is that darkening of the meat and fluid post-mortem due to oxidative enzyme reactions is minimized.

In accordance with the present invention, live crabs such as blue crab (Callinectes sapidus) and Dungeness crab (Cancer magister), are placed into a pressure vessel. The vessel is then filled with water at a temperature of 70-120° F. and pressurized to a pressure of at least substantially 240 MPa. While this pressure may be reached at various rates, in one embodiment, the vessel is pressurized at a rate of 100 MPa per minute or more. Further, while the pressure may be held for a range of times and provide beneficial results, in one embodiment, the pressure is held for a time of approximately 0.5 to 3 minutes.

While a variety of known systems may be used to carry out the inventive process, in one embodiment, batch operating systems such as those manufactured by the Assignee of the present application, Flow International Corporation, may be used. Examples of such Flow systems include the QFP 35L-600; QFP 215L-600; QFP 215L Ultra; QFP 320L; and HPP 687L Ultra. Information regarding these systems may be found on Flow's website located at www.avure.com, and such information is incorporated herein by reference in its entirety. It will be understood however, that any other comparable pressure system may be used to carry out the various embodiments of the present invention.

The temperature of the pressure vessel may be matched to the selected processing temperature of the water to minimize heat transfer, and the crabs may be pressurized, in accordance with the methods described in co-pending application Ser. No. 09/883,091 (U.S. Patent Publication No. 2002/0192109), which application is incorporated herein by reference in its entirety. The crabs and water provided at the selected processing temperature may also be pressurized in an isolation chamber of a pressure vessel, as is known in the art.

After the crabs are processed in accordance with the present invention, the meat is extracted by workers using hand tools, or by machines. The extracted product is then immediately packaged, then refrigerated or frozen.

By processing crabs in accordance with the present invention, the ease with which meat is extracted is greatly increased. Furthermore, the quantity and quality of meat recovered from the processed crabs is maximized, thereby increasing the market value of the end product.

### BRIEF DESCRIPTION OF THE SEVERAL VIEWS OF THE DRAWINGS

FIG. 1 is a diagram illustrating the steps of an embodiment of the present invention.

FIG. 2 is a schematic elevational view of a system used to carry out the present invention.

FIG. 3 is a photo showing the complete removal of meat from a crab leg, achieved in accordance with the present invention.

FIG. 4 is a photo showing complete removal of meat from a Dungeness crab in accordance with the present invention.

FIG. 5 is a photo demonstrating the complete removal of visceral mass and gonadal materials from a Dungeness crab in accordance with the present invention.

### DETAILED DESCRIPTION OF THE INVENTION

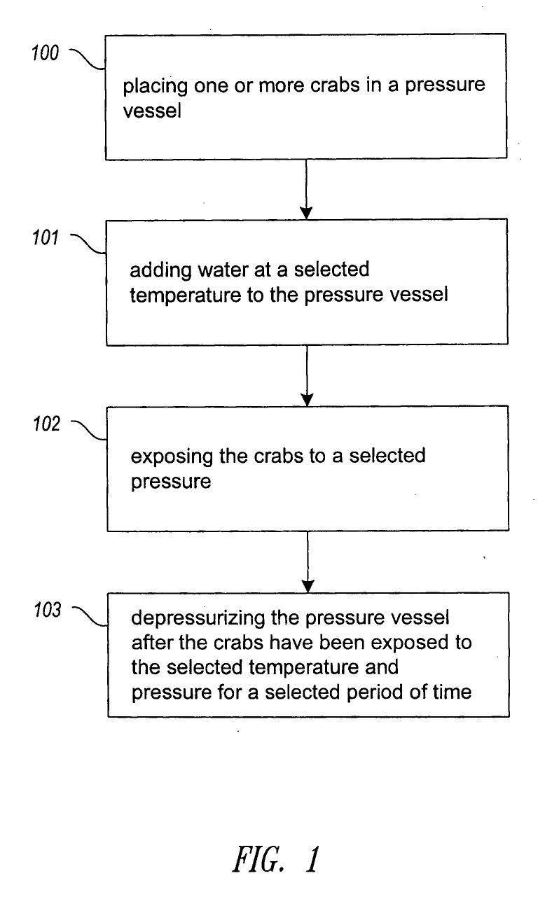

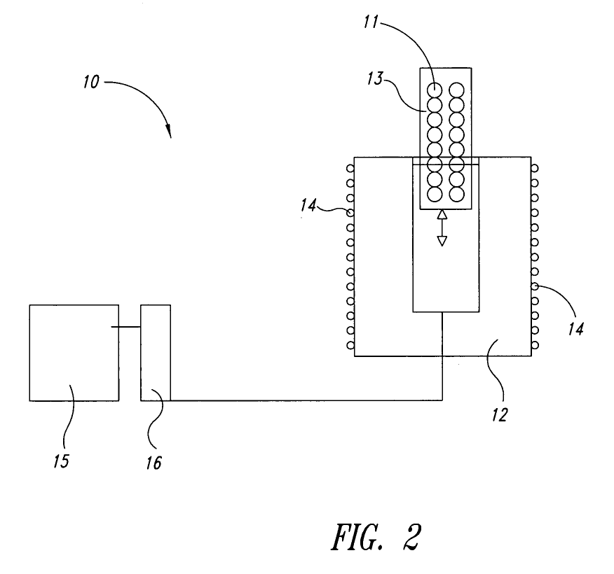

The quantity and quality of meat obtained from crabs is improved over conventional systems, as is the ease with which the meat is extracted, in accordance with the present invention. In a first embodiment, as illustrated in FIGS. 1 and 2, a high-pressure processing (HPP) system 10 is used to process crabs 11 in accordance with the present invention. More particularly, the crabs 11 are placed in a pressure vessel 13, for example via a product carrier 12, step 100. Water at a selected temperature is added to the pressure vessel, step 101. While this may be accomplished in a variety of ways known in the industry, in one embodiment, water from a source of ultrahigh-pressure fluid 15 passes through a heating device 16 prior to being introduced into the pressure vessel 13. The pressure vessel 13 may be heated to have a temperature that matches the selected temperature of the water, for example via heating elements 14 illustrated schematically in FIG. 2, and as described in co-pending application Ser. No. 09/883,091, which application is assigned to the Assignee of the present application.

Such HPP systems are known in the art, and will not be described in more detail. Examples of appropriate systems for carrying out the present invention include those manufactured by Flow International Corporation, such as the QFP 35L-600; QFP 215L-600; QFP 215L Ultra; QFP 320L; and HPP 687L Ultra. These batch systems may be used with or without a piston to effectively create an isolation chamber within the pressure vessel in which the crabs and water at a selected temperature are pressurized, as is known in the art. The crabs are therefore exposed to a selected pressure, step 102, and the pressure vessel 13 is depressurized after the crabs have been exposed to the selected temperature and pressure for a selected period of time, step 103. It will be understood that the water may be added to the pressure vessel prior to placing the crabs into the vessel, the water and crabs then being pressurized as described above by the addition of pressurized water to the vessel.

To achieve the goal of maximizing the quantity and quality of meat recovered from the crabs in accordance with the present invention, it is desired to achieve complete removal of the meat, as well as the visceral mass and gonadal materials from the crab. This allows the meat to be claimed in as large of pieces as possible, without skeletal or other unwanted material mixed in with the meat. It is also desirable to marginally denature the protein without cooking the meat and to minimize darkening of the meat and/or fluid, thereby improving the appearance, weight and market value of the meat.

All of these objectives are achieved in accordance with the present invention, by exposing the crabs to water having an initial temperature of 70-120° F. and a pressure of at least substantially 35,000 psi, which is approximately equivalent to 241 MPa. Even more preferred results are achieved when the temperature of the water is 85-120° F., and optimal balancing of benefits are achieved when the water is 100-120° F. While good meat separation, texture and color are achieved in all of these claimed temperature ranges, with the pressure at or above 35,000 psi, even more preferred results are achieved by processing at any of these temperature ranges at 40,000 psi. When the temperature of the water is above 120° F., an unwanted cooking effect results, over denaturing the meat.

The process parameters of temperature and pressure are the most important factors, in that order, and are somewhat independent of time and rate of pressurization. However, in an embodiment of the present invention, the crabs are subjected to the selected pressure for approximately 0.5 to 3 minutes, and the crabs are pressurized at a rate of at least 100 MPa per minute.

After the crabs are processed in accordance with the present invention, the meat is extracted by workers using hand tools, or by machines. The extracted product is then immediately packaged, then refrigerated or frozen.

High-pressure processing of shellfish to kill bacteria and to denature an oyster adductor muscle connective tissue to gel formation is taught in the prior art, for example, U.S. Pat. Nos. 6,426,103 and 6,537,601. However, these references teach to process shellfish at 50-130° F., at 10,000-60,000 psi, for 1-15 minutes. These references further teach that shucking of oysters occurs with pressures as low as 25,000 psi. In contrast, applicants have found that this broader range of processing parameters is not suitable for crabs. More particularly, pressure of at least 35,000 psi is required to fully separate crab meat and visceral materials from the crab shells. Furthermore, temperatures over 120° F. result in an undesirable cooking of the crab meat.

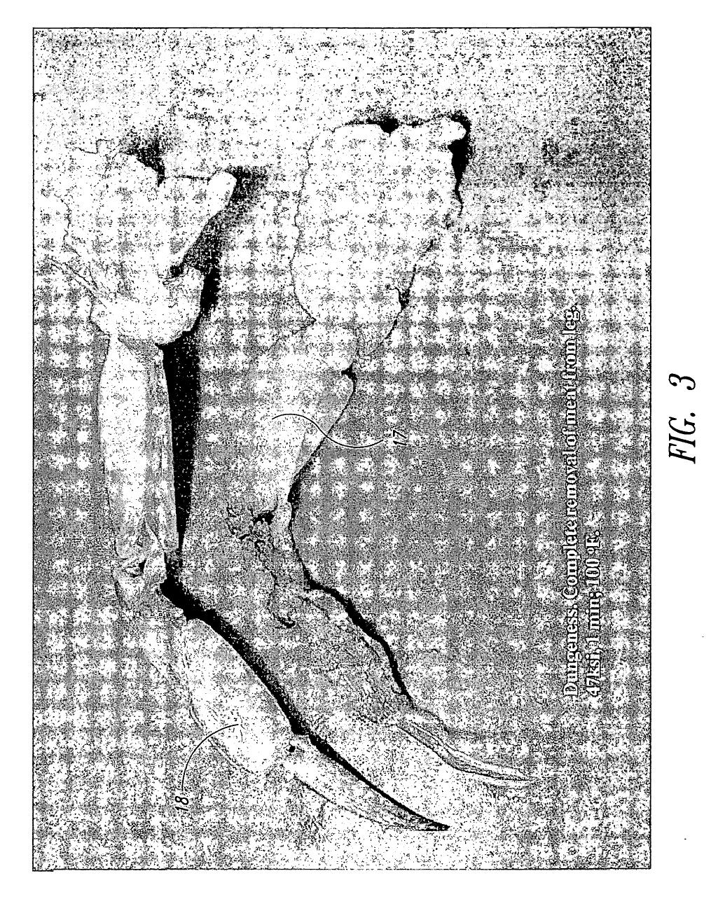

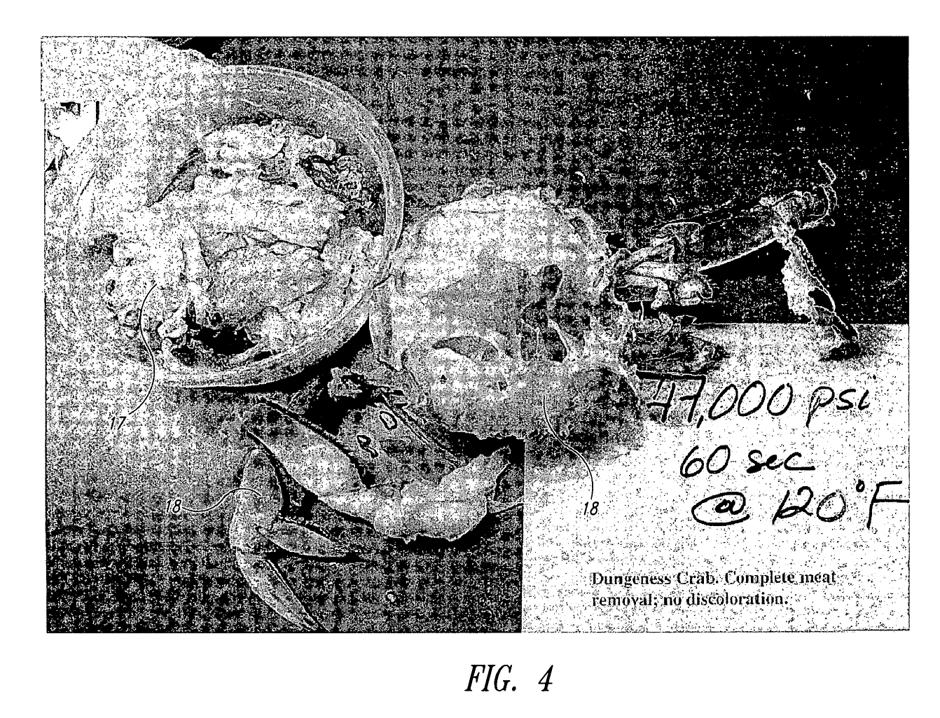

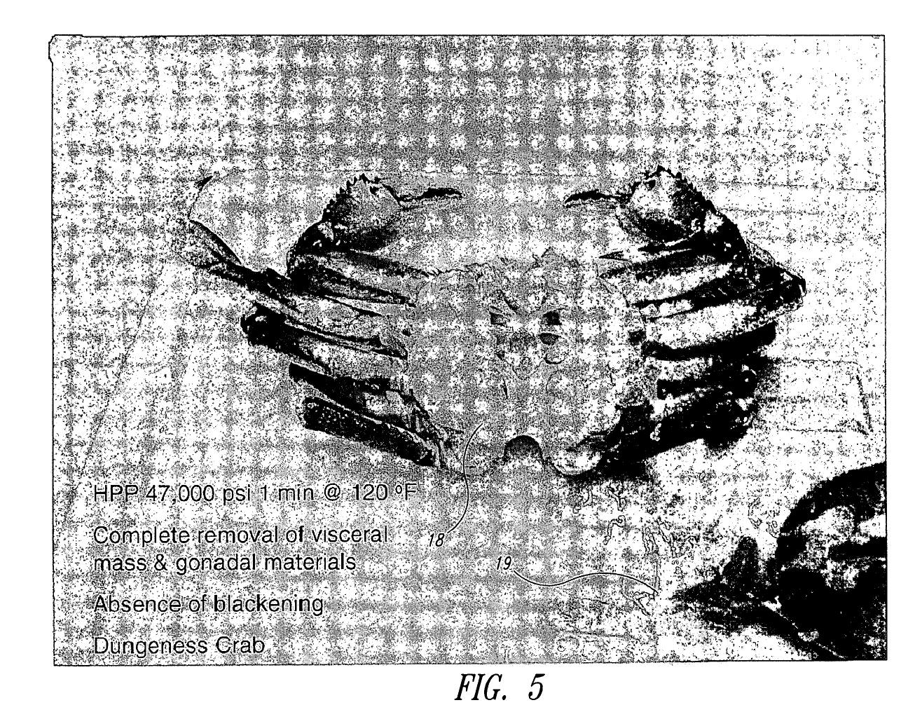

FIGS. 3, 4 and 5 illustrate the results achieved by processing crabs in accordance with the present invention. More particularly, FIG. 3 illustrates the complete removal of meat 17 from a crab leg. FIG. 4 illustrates the meat 17 recovered from a crab, illustrating complete separation of the meat 17 from the shell 18 and a lack of discoloration. FIG. 5 illustrates complete removal of the visceral mass and gonadal materials 19 from the crab shell 18, thereby allowing the meat to be completely harvested and separated from these unwanted materials.

It should further be noted that the meat beneficially retains more weight when processed in accordance with the present invention, thereby increasing the market value of the meat. Conventional methods for obtaining meat from crabs, namely cooking the crabs via steam or boiling, drives fluid out of the protein or meat. In contrast, applicants believe that by processing the crabs in accordance with the present invention, moisture found within the protein matrix is retained, thereby retaining the raw weight of the meat.

Therefore, in accordance with the present invention, crab meat protein is marginally denatured, avoiding the gelatinous nature of raw meat, but also avoiding the negative effects of cooking the meat. The crab meat is easily and completely removed from the exoskeleton of the crabs, as are the visceral mass and gonadal materials removed from the body cavities of the crabs. Unwanted darkening of the meat is minimized. As such, the present invention increases the quantity, quality and market value of meat obtained from crabs.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method for processing crabs, comprising:
placing one or more crabs in a pressure vessel;
inserting water into the pressure vessel, the water being at a temperature of substantially 70-120° F.; and
exposing the crabs to a pressure of at least substantially 35,000 psi.

2. The method according to claim 1, further comprising:
depressurizing the pressure vessel after the crabs have been exposed to the pressure of at least substantially 35,000 psi for approximately 0.5 to 3 minutes.

3. The method according to claim 2, further comprising:
extracting meat from the crabs via hand tools or machines.

4. The method according to claim 1, further comprising:
pressurizing the crabs at a rate of at least 100 MPa per minute.

5. A method for processing crabs, comprising:
placing one or more crabs in a pressure vessel;
inserting water into the pressure vessel, the water being at a temperature of substantially 85-120° F.; and
exposing the crabs to a pressure of at least substantially 35,000 psi.

6. The method according to claim 5, further comprising:
depressurizing the pressure vessel after the crabs have been exposed to the pressure of at least substantially 35,000 psi for approximately 0.5 to 3 minutes.

7. The method according to claim 6, further comprising:
extracting meat from the crabs via hand tools or machines.

8. The method according to claim 5, further comprising:
pressurizing the crabs at a rate of at least 100 MPa per minute.

9. A method for processing crabs, comprising:
placing one or more crabs in a pressure vessel;
inserting water into the pressure vessel, the water being at a temperature of substantially 100-120° F.; and
exposing the crabs to a pressure of at least substantially 35,000 psi.

10. The method according to claim 9, further comprising:
depressurizing the pressure vessel after the crabs have been exposed to the pressure of at least substantially 35,000 psi for approximately 0.5 to 3 minutes.

11. The method according to claim 10, further comprising:
extracting meat from the crabs via hand tools or machines.

12. The method according to claim 9, further comprising:
pressurizing the crabs at a rate of at least 100 MPa per minute.

13. The method according to claim 9 wherein the crabs are exposed to a pressure of at least 40,000 psi.
